(19) United States
(12) Patent Application Publication
(10) Pub. No.: US 2017/0171409 A1
(43) Pub. Date: Jun. 15, 2017

(54) IMAGE FORMING APPARATUS, METHOD FOR MANAGING ENERGY SAVING STATUS, AND NON-TRANSITORY COMPUTER-READABLE MEDIUM

(71) Applicant: Hisanori KAWAURA, Kanagawa (JP)

(72) Inventor: Hisanori KAWAURA, Kanagawa (JP)

(21) Appl. No.: 15/361,844

(22) Filed: Nov. 28, 2016

(30) Foreign Application Priority Data
Dec. 9, 2015 (JP) 2015-240272

(51) Int. Cl. H04N 1/00

(52) U.S. Cl. CPC H04N 1/00891; H04N 1/00896; H04N 1/00904; H04N 1/00344; H04L 67/02

(57) ABSTRACT

An image forming apparatus includes a network interface and circuitry. The network interface is configured to connect to a server and an information processing apparatus through a network. The circuitry is configured to set either one of a first connection mode and a second connection mode, execute a browser in the second connection mode, to cause the browser to receive from a web application via a network port an instruction for controlling image formation by the image forming apparatus, and to control the image forming apparatus to form the image in accordance with the instruction received from the web application, in the second connection mode, close a network port other than the network port that is used for communication with the web application, and in the first communication mode, controlling the image formation based on a print job data transmitted from the information processing apparatus.

### CROSS-REFERENCE TO RELATED APPLICATIONS

This patent application is based on and claims priority pursuant to 35 U.S.C. §119(a) to Japanese Patent Application No. 2015-240272, filed on Dec. 9, 2015 in the Japan Patent Office, the entire disclosure of which is hereby incorporated by reference herein.

### BACKGROUND

Technical Field

The present disclosure relates to an image forming apparatus, a method for managing energy saving status, and a non-transitory computer-readable medium.

Description of the Related Art

Cloud computing enables an information processing apparatus such as a client computer to use software provided on a network such as the Internet without executing an application. This cloud computing is usually implemented by a plurality of servers constituting a cloud to provide various services or functions to the information processing apparatus.

In recent years, the cloud computing is applied to a terminal that executes a job such as printing. Examples of the terminal include a printer such as an image forming apparatus.

On the other hand, some terminals have a main central processing unit (CPU) and a sub CPU. In view of saving power consumption, the main CPU is stopped while the terminal is in an energy saving mode, and the sub CPU that operates even in the energy saving mode processes network packets.

In those terminals, when the sub CPU receives the network packet that the sub CPU itself cannot process during the energy saving mode, the main CPU is reactivated to process the network packet.

However, it is difficult to keep the energy saving state in which the main CPU is stopped because the main CPU is reactivated to respond to an inquiry of the simple network management protocol (SNMP), which is frequently inquired on the network.

### SUMMARY

An image forming apparatus includes a network interface and circuitry. The network interface is configured to connect to a server and an information processing apparatus through a network. The circuitry is configured to: set either one of a first connection mode and a second connection mode; execute a browser in the second connection mode, to cause the browser to receive from a web application installed on the server via a network port an instruction for controlling image formation by the image forming apparatus, and to control the image forming apparatus to form the image in accordance with the instruction received from the web application via the network port; in the second connection mode, close a network port other than the network port that is used for communication with the web application in the second connection mode; and in the first communication mode, controlling the image forming apparatus to form the image based on a print job data transmitted from the information processing apparatus.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating an example of a configuration of an image forming system according to an embodiment of the present invention;

FIG. 2 is a block diagram illustrating an example of a hardware configuration of a cloud system included in the image forming system of FIG. 1;

FIG. 3 is a block diagram illustrating an example of hardware configurations of a client computer and a multifunction peripheral (MFP) included in the image forming system of FIG. 1;

FIG. 4 is a block diagram illustrating an example of a hardware configuration of a network controller included in the MFP of FIG. 3;

FIG. 5 is a block diagram illustrating an example of functional configurations of the cloud system, the client computer, and the MFP included in the image forming system of FIG.

FIG. 6 is a flowchart illustrating operation of setting a cloud connection mode performed by the MFP according to an embodiment of the present invention;

FIG. 7 is a flowchart illustrating operation of transitioning to an energy saving mode performed by the MFP according to an embodiment of the present invention;

FIG. 8 is a block diagram for explaining an example of a status of power supply to hardware components of the MFP in the energy saving mode according to an embodiment of the present invention;

FIG. 9 is a flowchart illustrating operation of acquiring own network settings performed by the MFP according to an embodiment of the present invention;

FIG. 10 is a flowchart illustrating operation of configuring network response settings in the energy saving mode performed by the MFP according to an embodiment of the present invention;

FIG. 11 is a flowchart illustrating operation of returning from the energy saving mode performed by the MFP according to an embodiment of the present invention;

FIG. 12 is a block diagram for explaining an example of the status of power supply to the hardware components of the MFP when the MFP returns from the energy saving mode according to an embodiment of the present invention;

FIGS. 13A and 13B are a sequence diagram illustrating operation of returning from the energy saving mode and a communication procedure for an inquiry to a management information base (MIB) according to an embodiment of the present invention;

FIG. 14 is a flowchart illustrating operation of setting the cloud connection performed by the MFP according to another embodiment of the present invention;

FIG. 15 is a flowchart illustrating operation of transitioning to the energy saving mode the MFP according to another embodiment of the present invention;

FIG. 16 is a flowchart illustrating operation of returning from the energy saving mode performed by the MFP according to another embodiment of the present invention, and FIGS. 17A and 17B are a sequence diagram illustrating a comparative example in which the MFP returns from the energy saving mode in response to receiving an inquiry to the MIB and thereby an energy saving state is interrupted according to the related art.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Several exemplary embodiments of the present invention are described hereinafter with reference to drawings.

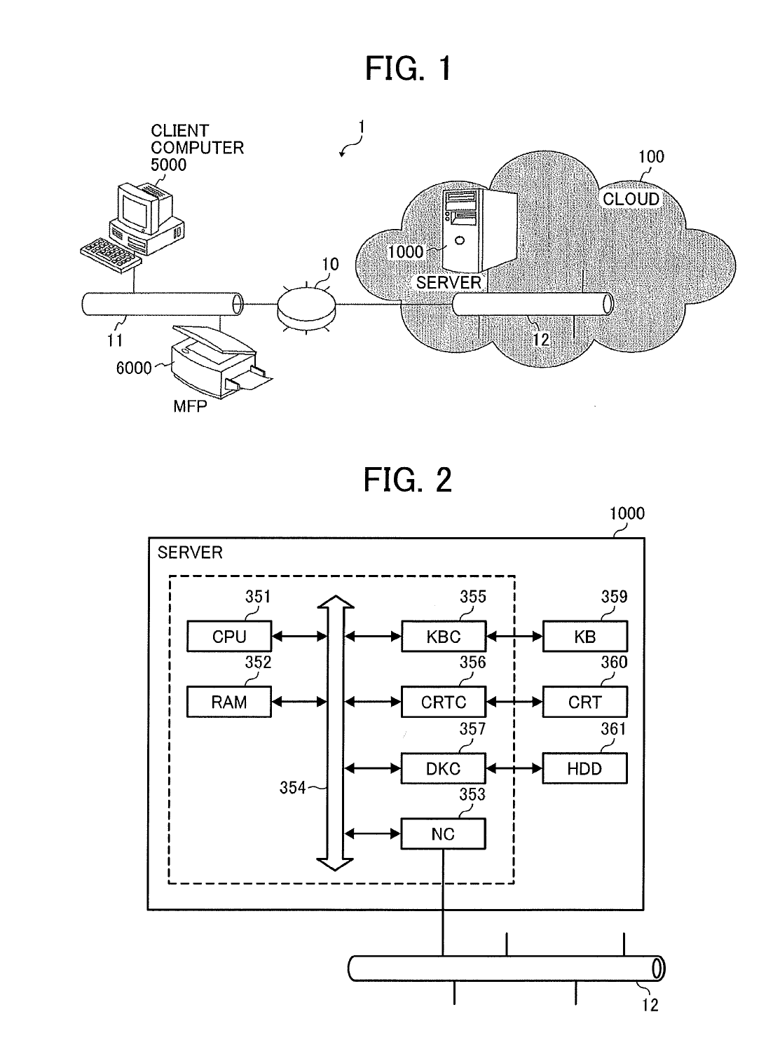

First, a description is given of a configuration of an image forming system 1 according to an embodiment of the present invention. FIG. 1 is a schematic diagram illustrating an example of the configuration of the image forming system 1.

The image forming system 1 of FIG. 1 includes a cloud system (“cloud”) 100, a client computer 5000, and a multifunction peripheral (MFP) 6000.

In the image forming system 1, the client computer 5000 as an example of an information processing apparatus and the MFP 6000 as an example of a terminal is connected to each other via a network 11 such as an intranet and a local area network (LAN).

Note that, although the image forming system 1 of FIG. 1 includes one MFP 6000, the MFP 6000 could be more than one. The MFP 6000 has multiple functions such as a copier function, a facsimile function, a printer function, and a scanner function.

The network 11 is connected to a network 10 such as the Internet on which a plurality of clouds reside. In FIG. 1, only one cloud 100 is illustrated to make the drawing simple.

The cloud 100 provides various services in response to a user request without even a user recognition of which server on the cloud 100 executes software such as programs to process the user request.

Cloud computing like this allows the user to avoid purchasing or installing new information processing apparatus or purchasing new applications. Accordingly, cloud computing allows the user to save the initial investment.

When the cloud computing is applied to the MFP 6000, the MFP 6000 supports basic functions and implements additional functions executed by the cloud 100 on the network 10. This reduces the cost of the MFP 6000 and adds advanced functions to the MFP 6000.

For example, when print job data generated by the client computer 5000 is in a format that the MFP 6000 does not support, the MFP 6000 cooperates with the cloud computing to cause the cloud 100 to convert the format of the print job data into another format that the MFP 6000 supports. The cloud 100 transmits the print job data in the converted format to the MFP 6000. The MFP 6000 performs printing in accordance with the print job data transmitted from the cloud 100.

The cloud 100 of FIG. 1 includes a server (server apparatus) 1000.

Although the cloud 100 includes only one server 1000 in an example illustrated in FIG. 1, the server 1000 could be more than one depending on the number of functions provided by the cloud 100.

The client computer 5000 transmits print job data to the server 1000 via the network 11 and the network 10.

The server 1000 accepts the job data from the client computer 5000 via the network 11 and the network 10. Further, the server 1000 processes the print job data received from the client computer 5000 to convert the format of the print job data to the one that the MFP 6000 can support. Then, the server 1000 transmits the processed print job data to the MFP 6000 via the network 12, the network 10, and the network 11.

The MFP 6000 executes a print job according to the processed print job data received from the cloud 100.

As described heretofore, the client computer 5000 and the MFP 6000 in a user environment are connected to the cloud 100 via the network 10 to constitute the image forming system 1.

Hereinafter, a description is given of a hardware configuration of the cloud 100.

FIG. 2 is a block diagram illustrating an example of the hardware configuration of the cloud 100 including the server 1000 illustrated in FIG. 1.

The server 1000, which is a web server, includes a central processing unit (CPU) 351, a random access memory (RAM) 352, a keyboard controller (KBC) 355, a cathode ray tube controller (CRTC) 356, a disk controller (DKC) 357, and a network controller (NC) 358. Those hardware components are connected to one another via a system bus 354.

The keyboard controller 355 controls key inputs by a keyboard (KB) 359 and a pointing device.

The CRT controller 356 controls display by a display (CRT) 360.

The disk controller 357 controls accesses to a hard disc drive (HDD) 361 storing a boot program, various applications, user files, edited files, etc.

The HDD 361 further stores a list of the MFPs 6000 (MFP list) that can access to the cloud 100, a list of the print job data being processed (job list), etc.

The network controller 358 is connected to one or more other servers and the network 10 via the network 12. The network controller 358 controls communication between the server 1000 and the other servers and communication between the server 1000 and the network 10.

The CPU 351 operates according to a control program such as an operating system (OS) stored in the HDD 361. Further, the CPU 351 processes jobs such as the print job according to a job acceptance program, etc., stored in the HDD 361. The CPU 351 uses the RAM 352 as a main memory and a work area, etc. Furthermore, the CPU 351 controls entire operation of the hardware components connected to the system bus 354.

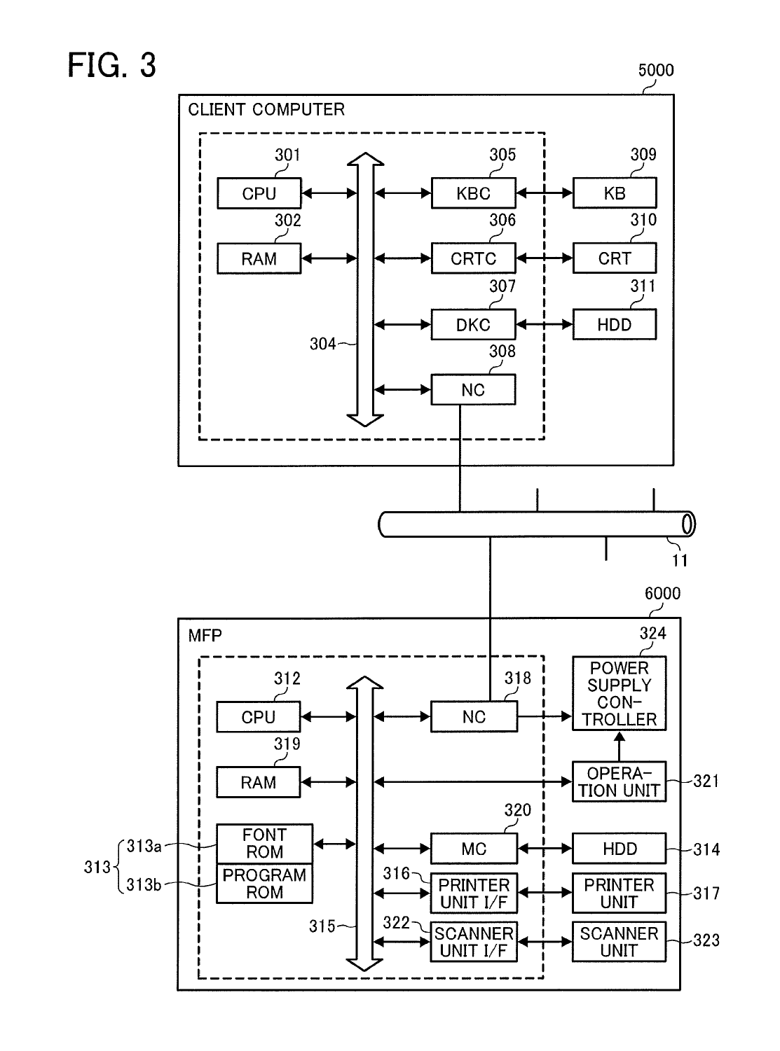

Hereinafter, a description is given of hardware configurations of the client computer 5000 and the MFP 6000. FIG. 3 is a block diagram illustrating an example of the hardware configurations of the client computer 5000 and the MFP 6000 illustrated in FIG. 1. The client computer 5000, which is an example of an information processing apparatus, includes a CPU 301, a RAM 302, a keyboard controller (KBC) 305, a CRT controller (CRTC) 306, a disk controller (DKC) 307, and a network controller (NC) 308.

The CPU 301, the RAM 302, the keyboard controller 305, the CRT controller 306, the disk controller 307, and the network controller 308 are connected to one another via a system bus 304.

Further, the keyboard controller 305, the CRT controller 306, and the disk controller 307 are respectively connected to a keyboard (KB) 309, a display (CRT) 310, and an HDD 311. Furthermore, the network controller 308 is connected to the network 11.

In the client computer 5000, the CPU 301 performs processing of generating document data containing graphics, images, text, and tables (including spreadsheets) according to a program. Further, the CPU 301 performs processing of generating the print job data for the document data.

The HDD 311 of the client computer 5000 stores an OS, etc., which is a control program for the CPU 301.

The network controller 308 of the client computer 5000 is connected to the MFP 6000 and the cloud 100 via the network 11 and the network 10 to control communication between the client computer 5000 and the MFP 6000 and communication between the client computer 5000 and the cloud 100.

Furthermore, the CPU 301 performs processing of rasterizing outline fonts into a display information RAM set on the RAM 302 to implement WYSIWYG (what you see is what you get) on the display 310. The CPU 301 uses the RAM 302 as a main memory and a work area, etc.

Still further, the CPU 301 opens various screens stored in advance in accordance with commands instructed with a mouse cursor, etc. displayed on the display 310 to perform various types of data processing. When performing printing, the CPU 301 opens a screen used for configuring print settings in accordance with a user operation to configure settings of the MFP 6000 (user input).

As illustrated in FIG. 3, the MFP 6000 includes a CPU 312, a ROM 313, a printer unit interface (I/F) 316, a network controller (NC) 318, a memory controller (MC) 320, and a scanner unit I/F 322.

The ROM 313 includes a font ROM 313a and a program ROM 313b.

The network controller 318, which constitutes a network interface, is connected to the network 11 and a power supply controller 324. The printer unit I/F 316 is connected to a printer unit (printer engine) 317. The memory controller 320 is connected to an HDD 314. The scanner unit I/F 322 is connected to a scanner unit 323.

As illustrated in FIG. 3, those hardware components of the MFP 6000 are connected to one another via a system bus 315. Further, an operation unit 321 is connected to the system bus 315.

The MFP 6000 is controlled by the CPU 312 as a main CPU in a normal mode. The CPU 312 operates according to a control program, etc., stored in the program ROM 313b or the HDD 314.

When performing printing, the CPU 312 receives the print job data from the client computer 5000 in a network connection mode. By contrast, in a cloud connection mode, the CPU 312 acquires the print data job from the cloud 100. The CPU 312 outputs image data as output information to the printer unit 317 via the printer unit I/F 316 to perform printing. The font ROM 313a stores font data, etc., to be used for generating the image data. The CPU 312 refers to the font data, etc., when performing printing.

Further, the CPU 312 transfers image data stored in the HDD 314 to the printer unit 317 via the printer unit I/F 316 to perform printing.

When performing scanning, the CPU 312 instructs the scanner unit 323 to operate via the scanner unit I/F 322. The scanner unit 323 scans a document to obtain image data. The CPU 312 stores the image data obtained by the scanner unit 323 in the HDD 314 via the memory controller 320.

When performing scanning, the CPU 312 transmits the image data to the cloud 100 or the client computer 5000 and exchanges various commands and statuses with the cloud 100 or the client computer 5000 via the network controller 318, as described later.

The CPU 312 communicates with the client computer 5000 and the cloud 100 via the network controller 318. For example, the CPU 312 notifies the client computer 5000 and the cloud 100 of various data in the MFP 6000 via the network controller 318. The CPU 312 uses the RAM 319 as a main memory and a work area, etc.

The operation unit 321 of FIG. 3 includes a display such as a liquid crystal display (LCD). The operation unit 321 further includes keys, a touch panel, a keyboard, and a mouse. The user can confirm various instructions to the MFP 6000 and an operating state of the MFP 6000 on the operation unit 321.

The MFP 6000 operates in several different modes. One of the different modes is an energy saving mode in which the power consumption of the MFP 6000 is saved. The MFP 6000 in the energy saving mode transitions to the normal mode in accordance with the user's operation of a specific key included in the operation unit 321.

The power supply controller 324 controls a power supply of the MFP 6000. The power supply controller 324 causes the MFP 6000 to transition among the energy saving mode, the normal mode, a standby mode, and an off-state, based on an instruction given via the network controller 318 or an instruction given from the operation unit 321.

In the energy saving mode, electronic power supply to most of the hardware components of the MFP 6000, including the CPU 312, is stopped. In an example illustrated in FIG. 3, the network controller 318 detects a factor requesting the MFP 6000 return from the energy saving mode to the normal mode. Accordingly, in the energy saving mode, electric power is supplied only to the network controller 318, the operation unit 321, and the power supply controller 324, for example.

Hereinafter, a description is given of a hardware configuration of the network controller 318 of the MFP 6000.

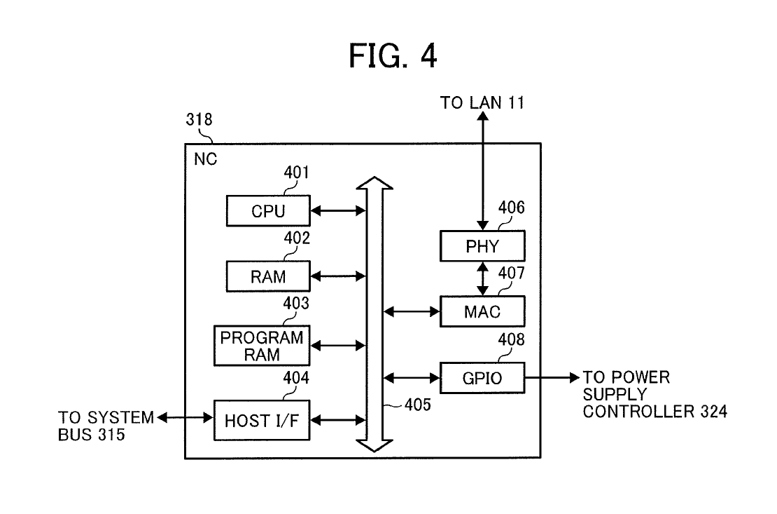

FIG. 4 is a block diagram illustrating an example of the hardware configuration of the network controller 318.

As illustrated in FIG. 4, the network controller 318 includes a CPU 401, a RAM 402, a program ROM 403, a host I/F 404, a physical layer (PHY) 406, a media access control (MAC) 407, and a general purpose input/output (GPIO) 408.

The CPU 401, the RAM 402, the program ROM 403, the host I/F 404, the PHY 406, the MAC 407, and the GPIO 408 are connected to one another via a system bus 405.

The host I/F 404 connects the network controller 318 of FIG. 4 to the system bus 315 (FIG. 2). Further, the PHY 406 connects the network controller 318 to the network 11 such as the LAN. Furthermore, the GPIO 408 connects the network controller 318 to the power supply controller 324.

The CPU 401 is a sub CPU that analyzes reception packets (also referred to as “received information”) described later to generate a transmission packet while the MFP 6000 is in the energy saving mode. Accordingly, a power-saving CPU is used for the CPU 401.

The CPU 401 executes programs stored in the program ROM 403 using the RAM 402 as a work area. The reception packets received via the network 11 is input to the PHY 406.

The MAC 407 converts a data format of the reception packets to a data format that the CPU 401 can support. The reception packets are temporarily stored in the RAM 402. Subsequently, the CPU 401 analyzes the reception packets.

The CPU 401 generates the transmission packet on the RAM 402 and transfers the transmission packet to the MAC 407. The MAC 407 transmits the transmission packet to the network 11 via the PHY 406.

The GPIO 408 is an input/output port controlled by the CPU 401. As described above, the GPIO 408 is connected to the power supply controller 324.

The GPIO 408 includes an output port for outputting an instruction for return from the energy saving mode. The CPU 401 accesses the GPIO 408 to cause the output port to output the instruction for the return from the energy saving mode to the power supply controller 324.

The CPU 312 (FIG. 3) accesses the network controller 318 via the host I/F 404. The host I/F 404 is not supplied with power in the energy saving mode.

When the MFP 6000 transitions from the energy saving mode to the normal mode and thereby the CPU 312 starts to operate, the CPU 312 sends a stop command to the CPU 401 via the host I/F 404 in the course of a return process from the energy saving mode. In response to the stop command, the CPU 401 stops operating.

This brings the CPU 312 to a state of being able to access the RAM 402 and the MAC 407. Thus, the network controller 308 becomes under control of the CPU 312.

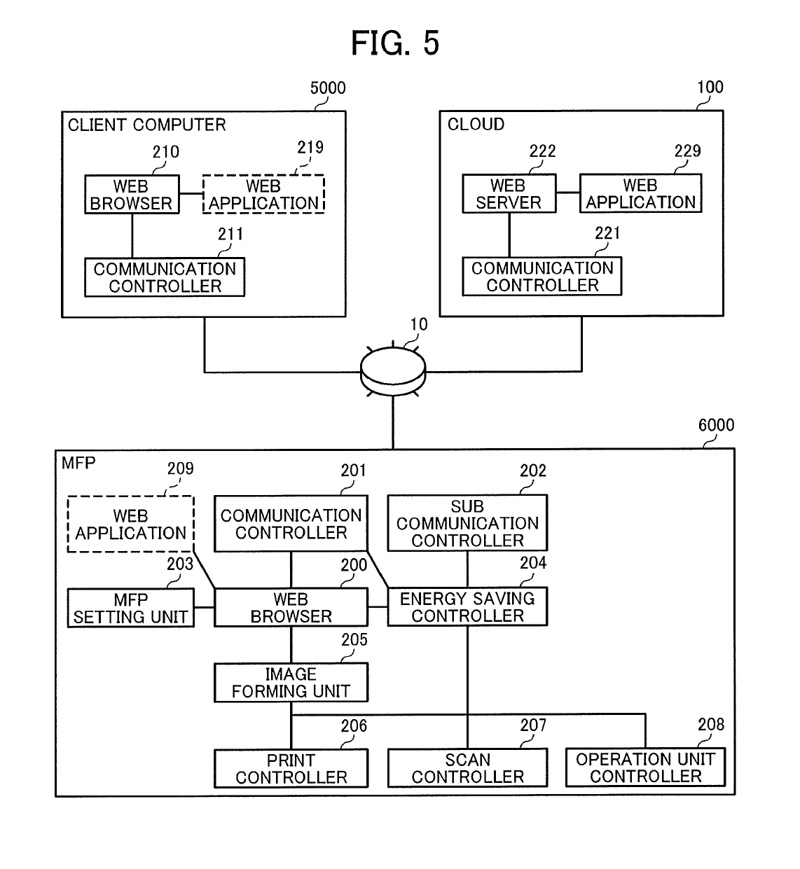

Hereinafter, a description is given of software configurations of the cloud 100 (server apparatus), the client computer 5000, and the MFP 6000 with reference to FIG. 5. FIG. 5 is a functional block diagram for explaining the software configurations of the cloud 100 (server apparatus), the client computer 5000, and the MFP 6000 illustrated in FIG. 1.

FIG. 5 illustrates at least a part of functions provided by software that the cloud 100, the client computer 5000, and the MFP 6000 include.

First, the software that operates on the cloud 100 includes a communication controller 221, a web server 222, and a web application 229.

The communication controller 221 is connected to the network (LAN) 12 and exchanges data such as packets with the MFP 6000 and the client computer 5000. Examples of the data such as packets include a web application, image data, and a command for notifying the status of the MFP 6000.

The web server 222 receives an http/https protocol request from the MFP 6000 or the client computer 5000 and sends back a reply to the MFP 6000 or the client computer 5000 in accordance with the received http/https protocol request.

The web application 229, as an example of a first web application, performs user authentication, user management, registration of image data, conversion of the image format, management of jobs, execution of jobs, management of the MFP 6000, and recording of logs of the MFP 6000.

Further, the software that operates on the client computer 5000 includes a communication controller 211, a web browser 210, and a web application 219.

The communication controller 211 is connected to the network 11 (LAN), the network 10, and the network 12, and exchanges data such as packets with the cloud 100 and the MFP 6000.

The web browser 210 sends the http/http protocol request to the web server 222 of the cloud 100 to display a web page or execute a web application. In this embodiment, the web application 219 executes the web application 229.

The web application 219 performs user authentication for using the cloud 100. Further, the web application 219 stores image data generated by the client computer 5000 in the cloud 100.

Furthermore, the software that operates on the MFP 6000 includes a communication controller 201, a sub communication controller 202, an MFP setting unit 203, a web browser 200, an energy saving controller 204, an image forming unit 205, a print controller 206, a scan controller 207, and an operation unit controller 208.

The communication controller 201 sends the http/https protocol request to the cloud 100 when the MFP 6000 operates in the normal mode.

In the cloud connection mode, the communication controller 201 opens only an http/https port that is used in the cloud connection mode, and closes a network port that is not necessary for communication in the cloud connection mode.

The sub communication controller 202 receives an inquiry for the status of MFP 6000, which is made by the cloud 100 as a part of the MFP management process even when the MFP 6000 is in the energy saving mode. Further, the sub communication controller 202 detects a setting of a timer and an excess of a period of time measured by the timer to cause the MFP 6000 to return from the energy saving mode using the power supply controller 324.

The MFP setting unit 203 changes settings of behaviors of the MFP 6000. Specifically, the MFP setting unit 203 sets an operating mode of the MFP 6000, between the network connection mode and the cloud connection mode. In the network connection mode, the MFP 6000 is used as a standard network printer. In the cloud connection mode, the MFP 6000 performs cloud connection. Further, the MFP setting unit 203 sets a period of time for transition to the energy saving mode. The MFP setting unit 203 constitutes a mode setting unit.

In other words, the MFP setting unit 203 sets the operating mode of the MFP 6000 to either one of the network connection mode (first connection mode) and the cloud connection mode (second connection mode). In the network connection mode, the MFP 6000 performs image formation based on the print job data transmitted from the client computer 5000 (information processing apparatus). In the cloud connection mode, the web browser 200 connects to the web application 229, and the MFP 6000 performs image formation based on an instruction received from the web application 229.

The web browser 200 is a software module (application software) that handles information resources on the network. The web browser 200 sends the http/https protocol request to the web server 222 of the cloud 100 to display a web page on the operation unit 321 or execute a web application. In this embodiment, a web application 209 executes the web application 229.

Further, the web browser 200 includes a web API used for controlling the MFP 6000. In accordance with web API requests from the web application 209, the web browser 200 issues control requests to the image forming unit 205 or notify an event in the MFP 6000.

The web browser 200 receives the instruction for image formation from the web server 222 and executes the instruction.

The web browser 200 transmits a session continuation notification (request) to the web server 222 when the MFP 6000 returns from the energy saving mode.

The web browser 200 is a browser that connects to the web application 229 provided in the web server 222 via the network controller 318 as a network interface. The web browser 200 instructs the image forming unit 205 to form an image in accordance with an instruction for the image formation received from the web application 229 via the web browser 200.

The web application 209 performs user authentication for using the cloud 100. Further, the web application 209 sets a job of the image data generated by the client computer 5000 and executes the job. The web application 209 constitutes a management unit. Furthermore, the web application 209 manages events in the MFP 6000 and records a log. When the cloud connection mode is set, the web application 209 closes the network port that is not necessary for communication in the cloud connection mode. The web application 209 constitutes a port closing unit.

The energy saving controller 204 performs a process of transition to the energy saving mode, when the period of time for transition to the energy saving mode that is set by the MFP setting unit 203 has passed. In the process of transition to the energy saving mode, the energy saving controller 204 controls the power supply of the MFP 6000 using the power supply controller 324, or controls a request to or switching of the sub communication controller 202 that monitors events in the energy saving mode.

The energy saving controller 204 turns on power to the hardware components necessary in the cloud connection mode and turns off power to the other hardware components.

Specifically, the energy saving controller 204 causes the power supply controller 324 to turn off the power supply of the hardware components except for the RAM 319, the network controller 318, and the power supply controller 324.

The image forming unit 205 issues a control request to the print controller 206 and the scan controller 207. Further, the image forming unit 205 notifies the web browser 200 of events in the printer unit 317 and the scanner unit 323.

The print controller 206, in accordance with the request from the image forming unit 205, controls timing for operating the printer unit 317 (FIG. 3). Further, the print controller 206 notifies the image forming unit 205 of the status of the printer unit 317.

The scan controller 207, in accordance with the request from the image forming unit 205, controls timing for operating the scanner unit 323. Further, the scan controller 207 notifies the image forming unit 205 of the status of the scanner unit 323.

The operation unit controller 208 displays the MFP setting unit 203, the web application 209, and the image forming unit 205 on the operation unit 321.

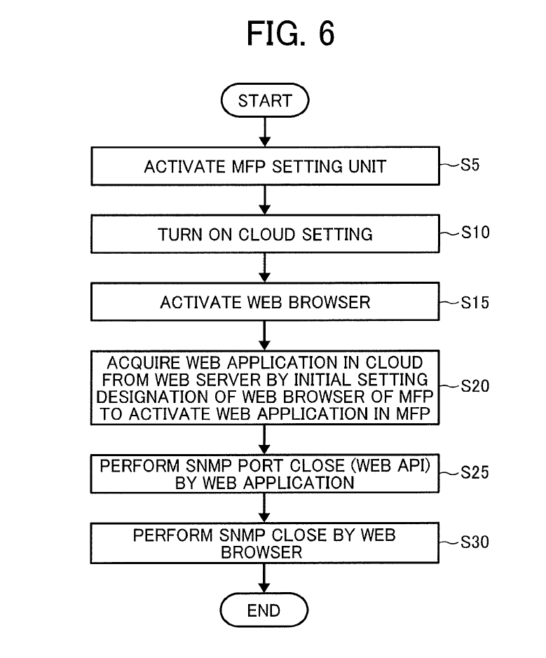

Hereinafter, a description is given of an operation of setting the cloud connection mode performed by the MFP 6000. FIG. 6 is a flowchart for explaining an operation of setting the cloud connection mode performed by the MFP 6000.

First, at S5, the MFP setting unit 203 is activated. At S10, the MFP setting unit 203 turns on the cloud setting. Thus, the MFP 6000 is set to the cloud connection mode.

Subsequently, at S15, the MFP setting unit 203 activates the web browser 200.

At S20, the web browser 200 acquires the web application 229 from the web server 222 with an initial URL designation of the web browser 200, and activates the web application 229 as the web application 209.

The web application 209 is the web application 229 acquired from the web server 222. The web application 209 performs the user authentication, the user management, the registration of image data, the conversion of an image format, the management of jobs, the execution of jobs, the management of the MFP 6000, and the recording of logs of the MFP 6000.

At S25, the web application 209 executes a web API to close an SNMP (simple network management protocol) port that is used for the network management protocol SNMP. At S30, the web browser 200 causes the communication controller 201 to close the SNMP port used for the network protocol SNMP, and the processing ends.

With the processing of the flowchart of FIG. 6, the communication controller 201 of the MFP 6000 is switched to the cloud connection mode. Thus, the http/https port used in the cloud connection mode is opened, while the network port that is not used in the cloud connection mode is closed.

As described heretofore, when the cloud connection mode is set, the network port that is not necessary in the cloud connection mode is closed. Accordingly, the cloud connection state is maintained, and the energy saving state is maintained as long as possible.

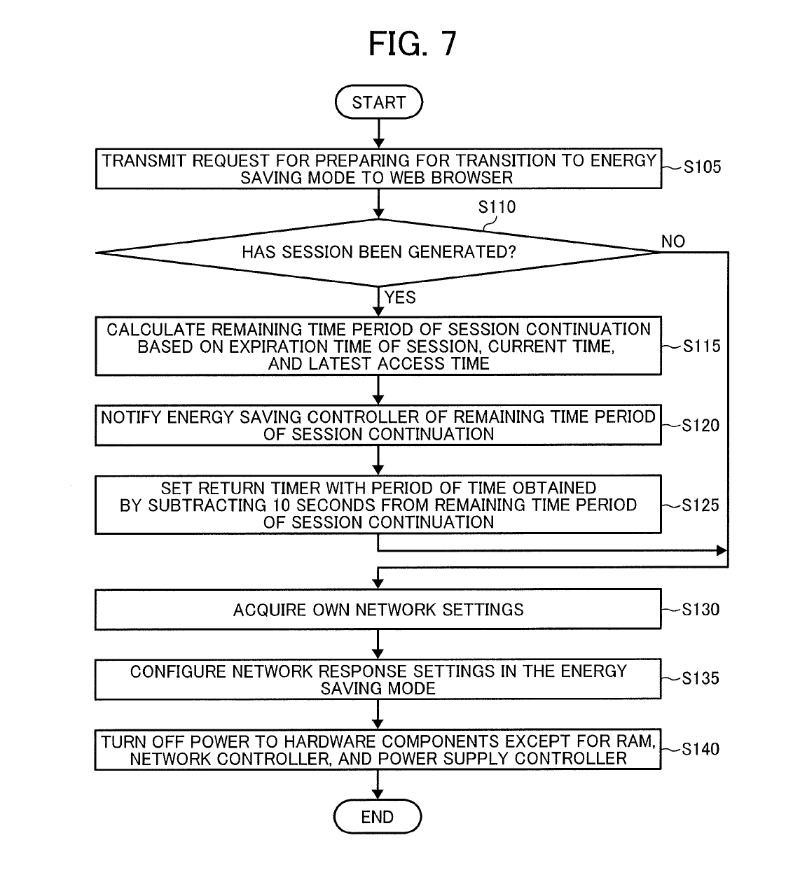

Hereinafter, a description is given of an operation of transitioning to the energy saving mode performed by the MFP 6000. FIG. 7 is a flowchart for explaining the operation of transitioning to the energy saving mode performed by the MFP 6000.

First, at S105, when the period of time for transition to the energy saving mode has passed while the MFP 6000 is in an uncontrolled state, the energy saving controller 204 transmits, to the web browser 200, a request for preparing for transition to the energy saving mode.

At S110, in response to receiving the request for preparing for transition to the energy saving mode, the web browser 200 checks whether a session has been generated. In other words, the web browser 200 checks whether the session established between the MFP 6000 and the cloud 100 is still active.

When the web browser 200 determines that the session has been generated (S110: YES), at S115, the web browser 200 calculates a remaining time period X during which the session is to be continued, based on an expiration time of the session, a current time, and a latest access time.

In other words, when the MFP 6000 transitions to the energy saving mode, the web browser 200 calculates a timeout period (expiration time of the session) during which the web browser 200 is to maintain the cloud connection mode, and sets the timeout period as a period of time for return from the energy saving mode.

Subsequently, at S120, the web browser 200 notifies the energy saving controller 204 of the calculated remaining time X.

Thus, the energy saving controller 204 turns on power only to the hardware components necessary in the cloud connection mode and turns off power to the other hardware components. Further, the web browser 200 receives the instruction for image formation from the web server 222 and executes the received instruction. Furthermore, when the MFP 6000 transitions to the energy saving mode, the web browser 200 calculates the timeout period during which the cloud connection mode is to be maintained, and sets the timeout period as the period of time for return from the energy saving mode.

Accordingly, the cloud connection state is maintained until the period of time for return from the energy saving mode has passed, and the energy saving state is maintained as long as possible.

Subsequently, at S125, the energy saving controller 204 causes the sub communication controller 202 to set a return timer with a period of time Y, which is obtained by subtracting 10 seconds from the remaining time X. In this example, 10 seconds as a margin is subtracted from the remaining time X considering time it takes for the MFP 6000 to return from the energy saving mode. This period of time as a margin is adjusted depending on the characteristics of the MFP 6000.

Subsequently, at S130, the energy saving controller 204 acquires own network settings from the communication controller 201. At 5135, the energy saving controller 204 configures network response settings for the energy saving mode to the sub communication controller 202.

At S140, the energy saving controller 204 causes the power supply controller 324 to turn off power to the hardware components except for the RAM 319, the network controller 318, and the power supply controller 324.

By contrast, when, in response to receiving the request for transition to the energy saving mode, the web browser 200 determines that no session has been generated (S110: NO), the processing proceeds to S130 without setting the return timer, and the energy saving controller 204 acquires own network settings (S130). Then the processing from 5135 and S145 is performed.

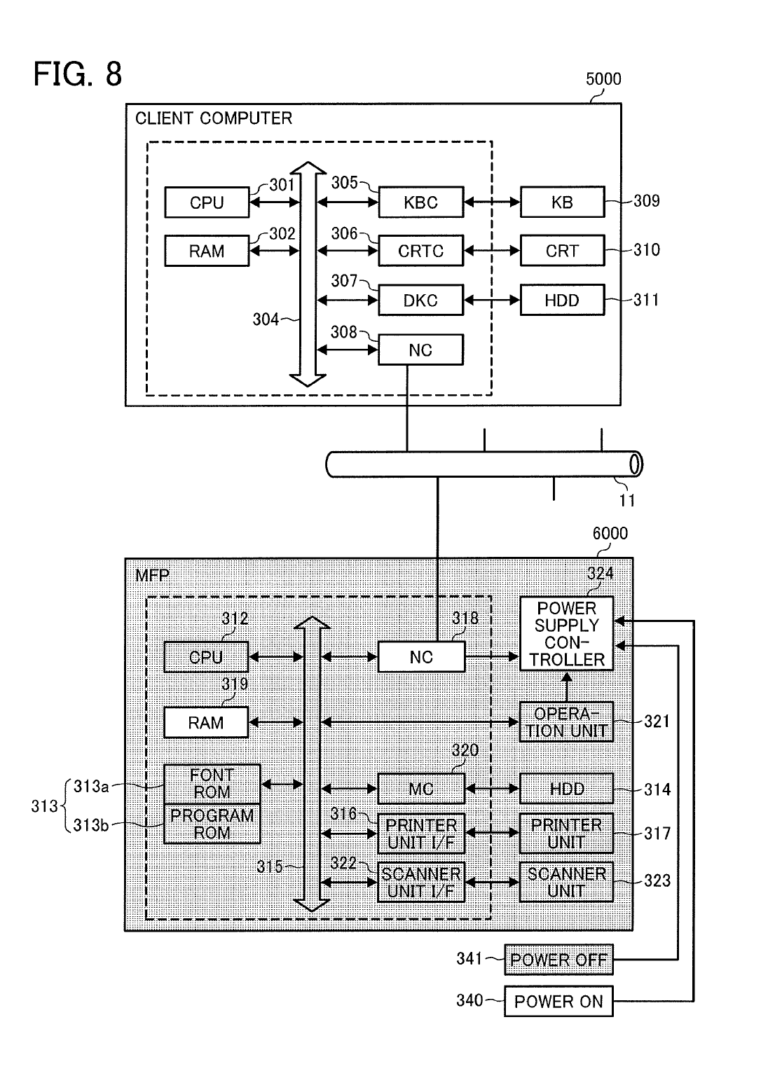

Hereinafter, a description is given of a status of power supply to the hardware components of the MFP 6000 in the energy saving mode with reference to FIG. 8.

FIG. 8 is a block diagram for explaining an example of the status of power supply to the hardware components of the MFP 6000 in the energy saving mode. In FIG. 8, the same reference numbers are allocated to elements (members or components) having the same function as those of FIG. 3 and redundant descriptions thereof are omitted below.

As illustrated in FIG. 8, the MFP includes a power-on key 340 and a power-off key 341, each being connected to the power supply controller 324.

In the MFP 6000, after executing the operation of transitioning to the energy saving mode as illustrated in FIG. 7, power to the hardware components except for the RAM 319, the network controller 318, the power supply controller 324, and the power-on key 340 is turned off.

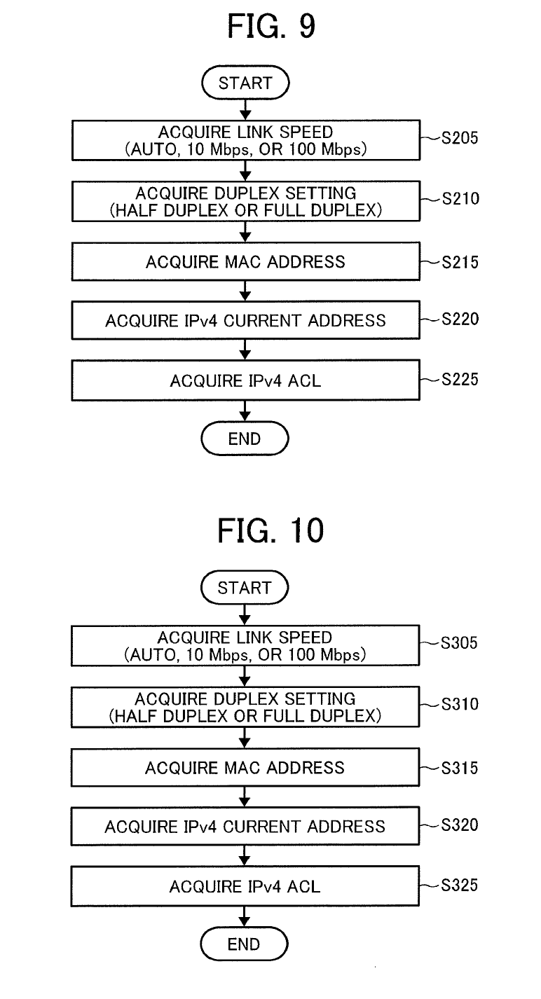

Hereinafter, a description is given of an operation of acquiring own network settings at S130 of FIG. 7. FIG. 9 is a flowchart for explaining the operation of acquiring own network settings performed by the MFP 6000.

First, at S205, the communication controller 201 acquires a link speed (AUTO, Mbps, or 100 Mbps).

Subsequently, at S215, the communication controller 201 acquires a duplex setting (half duplex or full duplex).

At S215, the communication controller 201 acquires a media access control (MAC) address.

At S220, the communication controller 201 acquires an Internet Protocol version 4 (IPv4) current address.

At S215, the communication controller 201 acquires an IPv4 access control list (ACL), and the processing ends.

Note that the ACL is a scheme that monitors transiting packets for filtering to pass or block the packets in accordance with communication requirements. In a case in which the ACL is set in the client computer 5000 as an example of the information processing apparatus by an administrator, the list information is transferred to the MFP 6000.

Hereinafter, a description is given of an operation of configuring the network response settings in the energy saving mode at 5135 of FIG. 7. FIG. 10 is a flowchart for explaining the operation by the MFP 6000 of configuring the network response settings in the energy saving mode.

First, at 5305, the communication controller 201 sets the link speed (AUTO, 10 Mbps, or 100 Mbps).

Subsequently, at 5310, the communication controller 201 configures the duplex setting (half duplex or full duplex).

At S315, the communication controller 201 sets the MAC address.

At S320, the communication controller 201 sets the IPv4 current address.

At S325, the communication controller 201 sets the IPv4 ACL, and the processing ends.

With this processing, the MFP 6000 determines whether a packet actually reaches the MFP 6000, and responds to a basic inquiry such as address resolution protocol (ARP) and packet internetwork groper (ping) in the packet that is permitted to pass through. By contrast, an inquiry other than the basic inquiry is used as an event for returning from the energy saving mode. Note that ARP is a protocol for acquiring information of a MAC address of the Ethernet (registered trademark) from an IP address. Further, ping is a command to check the reachability of an IP packet.

Hereinafter, a description is given of an operation performed by the MFP 6000 of returning from the energy saving mode and continuing the session.

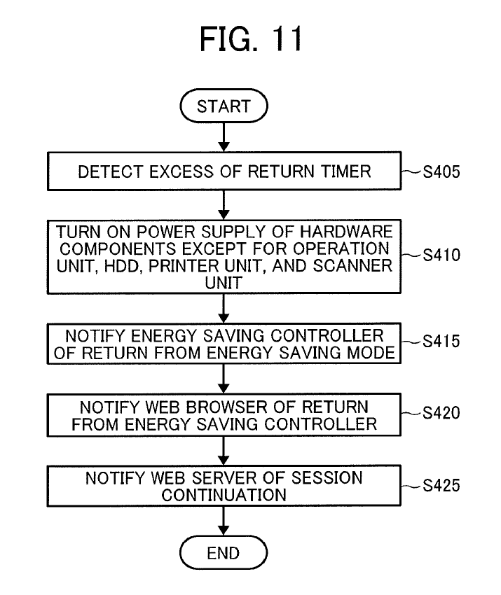

Hereinafter, a description is given of an operation performed by the MFP 6000 of returning from the energy saving mode and continuing the session. FIG. 11 is a flowchart for explaining the operation performed by the MFP 6000 of returning from the energy saving mode and continuing the session.

First, at S405, the sub communication controller 202 detects that a period of time measured by the return timer exceeds the period of time Y that is set at S125.

At S410, the sub communication controller 202 causes the power supply controller 324 to turn on the power supplies of the hardware components of the MFP 6000 except for the operation unit 321, the HDD 314, the printer unit 317, and the scanner unit 323.

At S415, the sub communication controller 202 transmits a notification of return from the energy saving mode to the energy saving controller 204.

At S420, the energy saving controller 204 transmits the notification of return from the energy saving mode to the web browser 200.

At S425, the web browser 200 transmits the session continuation notification to the web server 222.

Thus, when the MFP 6000 returns from the energy saving mode, the web browser 200 transmits the session continuation notification to the web server 222, and thereby the session is maintained. When it reaches the time for transition to the energy saving mode, the MFP 6000 again transitions to the energy saving mode.

Accordingly, as the session is maintained, the cloud connection state is maintained, while the energy saving state is maintained as long as possible.

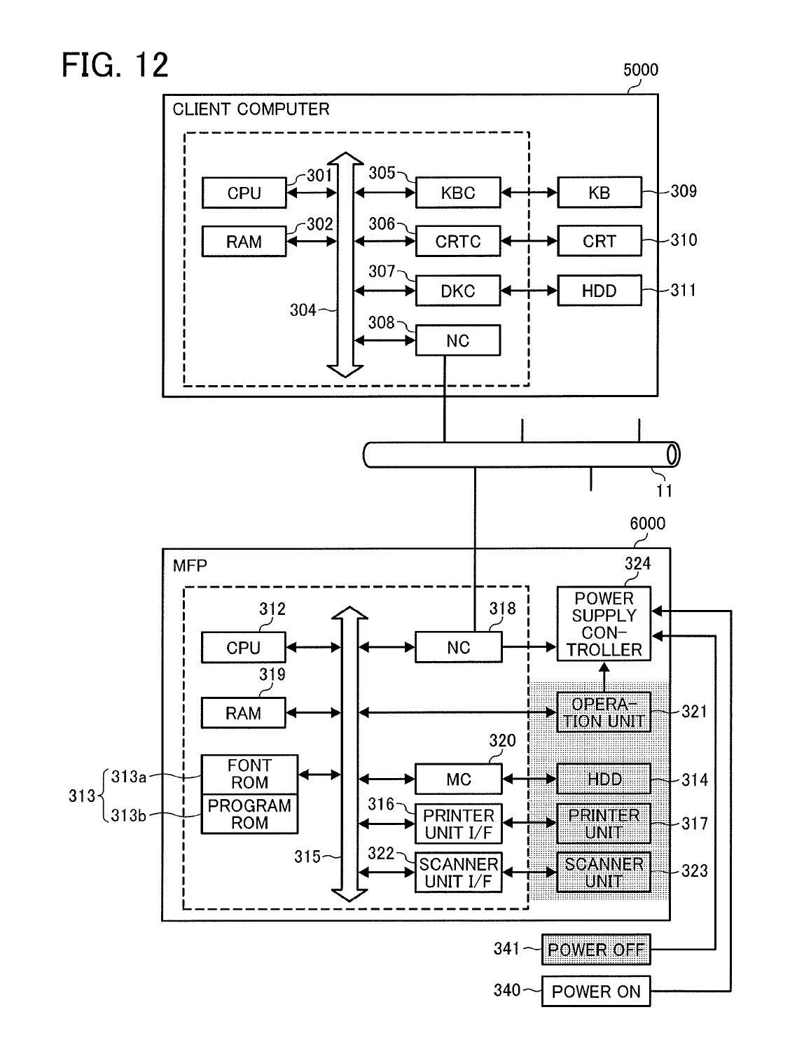

Hereinafter, a description is given of a status of power supply to the hardware components of the MFP 6000 when the MFP 6000 returns from the energy saving mode. FIG. 12 is a block diagram for explaining an example of the status of power supply to the hardware components of the MFP 6000 when the MFP returns from the energy saving mode. In FIG. 12, the same reference numbers are allocated to elements (members or components) having the same function as those of FIG. 8 and redundant descriptions thereof are omitted below.

In the MFP 6000, after executing the operation of returning from the energy saving mode as illustrated in FIG. 11, the power supplies of the hardware components except for the operation unit 321, the HDD 314, the printer unit 317, the scanner unit 323, and the power-off key 341 are turned on.

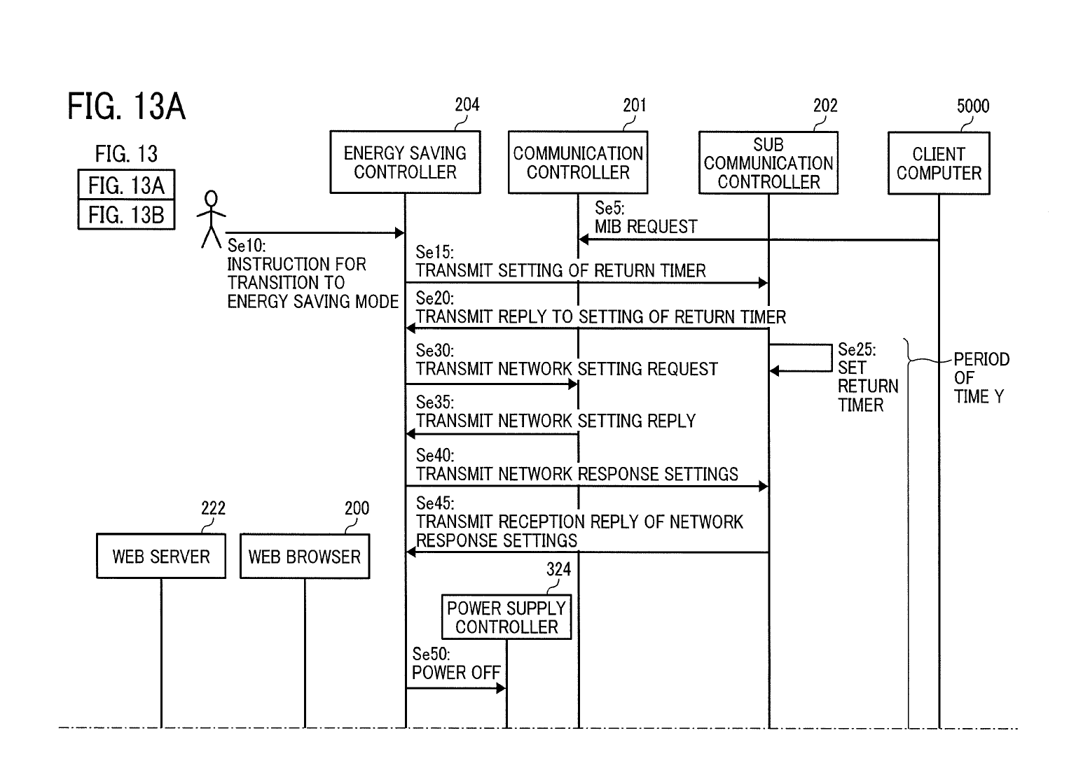

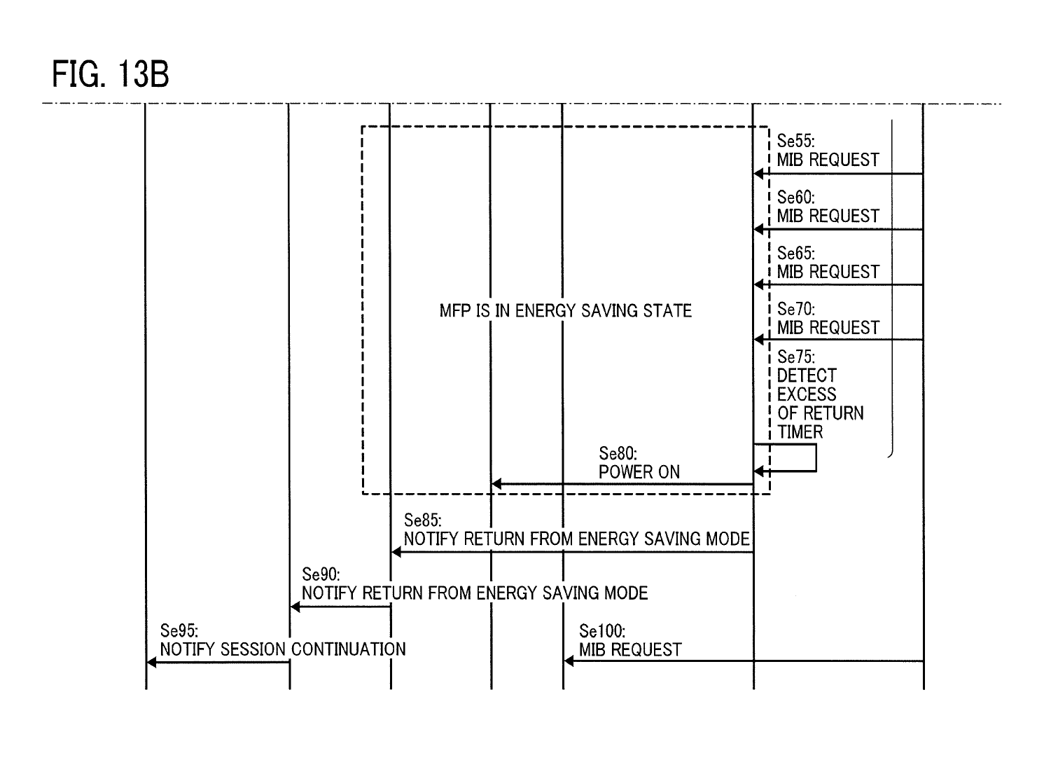

Hereinafter, a description is given of an operation of returning from the energy saving mode and a communication procedure for an inquiry to a management information base (MIB) according to this embodiment. FIGS. 13A and 13B are a sequence diagram for explaining the operation of returning from the energy saving mode and the communication procedure for an inquiry to the MIB according to this embodiment.

Specifically, FIGS. 13A and 13B illustrate a sequential operation of transitioning to the energy saving mode and returning from the energy saving mode as illustrated in FIGS. 7 to 12 and the communication procedure when the client computer 5000 makes an inquiry to the MIB of the MFP 6000 according to this embodiment.

At Se5, the client computer 5000 sends a MIB request to the communication controller 201. At this time, the communication controller 201 ignores the MIB request transmitted from the client computer 5000 both when the MFP 6000 operates in the normal mode and when the MFP 6000 operates in the energy saving mode.

At Se10, the energy saving controller 204 receives a user instruction for transition to the energy saving mode input via the operation unit 321. At Se15, the energy saving controller 204 transmits the setting of the return timer to the sub communication controller 202 in order to execute the user instruction.

At Se20, the sub communication controller 202 transmits a reply to the setting of the return timer to the energy saving controller 204. Further, at Se25, the sub communication controller 202 sets the return timer with the period of time Y during the preparation for transition to the energy saving mode.

At Se30, the energy saving controller 204 transmits a network setting request to the communication controller 201.

At Se35, the communication controller 201 transmits a network setting reply to the energy saving controller 204.

At Se40, the energy saving controller 204 transmits the network response settings to the sub communication controller 202.

At Se45, the sub communication controller 202 transmits a reception reply to the network response settings to the energy saving controller 204.

At Se50, the energy saving controller 204 transmits an instruction for turning off the power supply to the power supply controller 324.

In response to receiving the instruction for turning off the power supply from the energy saving controller 204, the power supply controller 324 causes the MFP 6000 to transition to the energy saving mode. In the energy saving mode, electric power supply to most of the hardware components of the MFP 6000, including the CPU 312, is stopped.

Specifically, the power supply controller 324 turns off power to the hardware components of the MFP 6000 except for the RAM 319, the network controller 318, and the power supply controller 324.

While the MFP 6000 is in the energy saving mode, the sub communication controller 202 does not accept the MIB requests transmitted from the client computer 5000 at Se55, Se60, Se65 and Se70.

At Se75, the sub communication controller 202 detects that a period of time measured by the return timer reaches the period of time Y that is set at Se25.

At Se80, based on the detection, the sub communication controller 202 transmits an instruction for turning on the power supply to the power supply controller 324.

Thus, the MFP 6000 to return from the energy saving mode. Accordingly, electric power is supplied to the hardware components of the MFP 6000 except for the operation unit 321, the HDD 314, the printer unit 317, the scanner unit 323, and the power-off key 341.

At Se85, the sub communication controller 202 notifies the energy saving controller 204 of the return from the energy saving mode. Further, at Se90, the energy saving controller 204 notifies the web browser 200 of the return from the energy saving mode. Furthermore, at Se95, the web browser 200 notifies the web server 222 of the continuation of the session.

At Se100, the client computer 5000 sends the MIB request to the communication controller 201. The communication controller 201 ignores the MIB request from the client computer 5000 in the similar way as at Se5.

As illustrated in the sequence diagram of FIGS. 13A and 13B according to the this embodiment, even when the sub communication controller 202 receives the MIB requests from the client computer 5000 at Se55, Se60, Se65 and Se70, the communication controller 201 is maintained in the energy saving state.

In other words, as illustrated in the sequence diagram of FIGS. 13A and 13B according to the this embodiment, the MIB requests (Se55 to Se70) transmitted from the client computer 5000 to the sub communication controller 202 before the period of time Y (the timeout period) set with the return timer has passed are ignored.

This is because the network port other than the http/https port used for the cloud connection is closed in a case in which the cloud connection mode is set in an initial setting of the MFP 6000.

Further, in preparation for transition to the energy saving state, the timeout period for the http/https session is calculated, and the return timer is set based on the remaining time period. Accordingly, session continuation is performed to the web server 222 before the session is timeout.

With such operation, when the cloud connection is established in the MFP 6000 that supports a cloud connection function and is capable of transitioning to the energy saving state, the network protocol such as the SNMP, which is not necessary in the cloud connection mode, is stopped, and thereby the energy saving state is maintained as long as possible.

Accordingly, when the cloud connection mode is set, the network port that is not necessary in the cloud connection mode is closed. In this case, the MFP 6000 receives the print job data from the web server 222 via the network port used in the cloud connection mode.

Thus, when the cloud connection mode is set, the network port that is not necessary in the cloud connection mode is closed. Further, the MFP 6000 is able to receive the print job data from the web server 222 via the network port used in the cloud connection mode. Accordingly, the MFP 6000 is able to receive the print job data from the web server 222 in the cloud connection state and in the energy saving state.

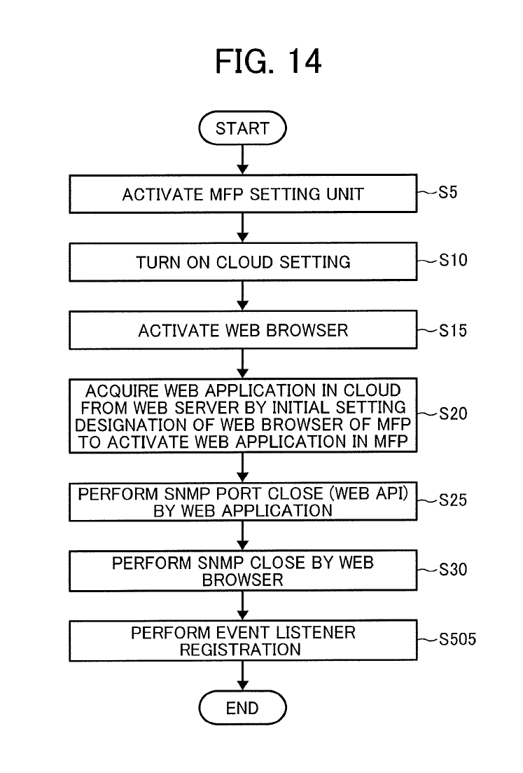

Hereinafter, a description is given of another embodiment of the present invention in which the continuation of the session is performed based on a notification of an event of the MFP 6000 such as the transition to the energy saving mode and the return from the energy saving mode. First, a description is given of an operation of setting the cloud connection mode performed by the MFP 6000 according to this embodiment. FIG. 14 is a flowchart for explaining the operation of setting the cloud connection mode performed by the MFP 6000.

In FIG. 14, the same step numbers are allocated to the same operations as those in the flowchart of FIG. 6, and redundant descriptions thereof are omitted below. Accordingly, the description is given of operations that are different from those in the flowchart of FIG. 6.

In this embodiment, after the web browser 200 causes the communication controller 201 to close the SNMP port used for the network management protocol SNMP (S30), the processing proceeds to S505.

At S505, the web application 209 performs an event listener registration to the web browser 200 to enable the web application 209 to acquire the event notification of the MFP 6000.

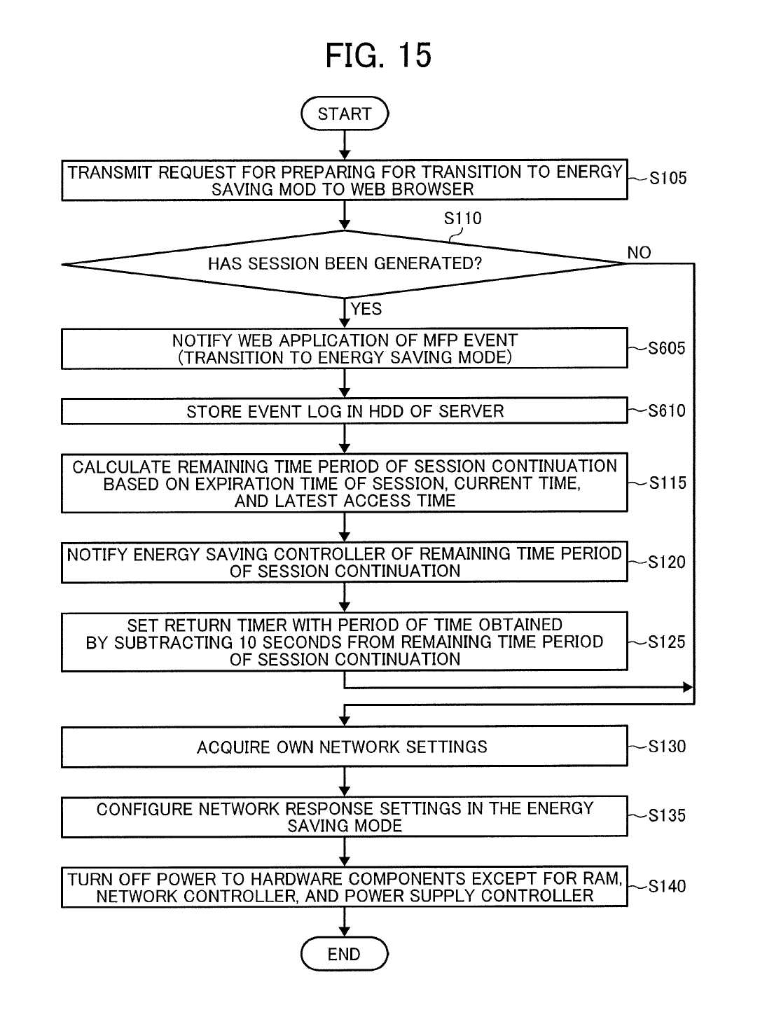

Hereinafter, a description is given of an operation of transitioning to the energy saving mode performed by the MFP 6000 according to this embodiment. FIG. 15 is a flowchart for explaining the operation of transitioning to the energy saving mode performed by the MFP 6000 according to this embodiment.

In FIG. 15, the same step numbers are allocated to the same operations as those in the flowchart of FIG. 7, and redundant descriptions thereof are omitted below. Accordingly, the description is given of operations that are different from those in the flowchart of FIG. 7.

In this embodiment, after the web browser 200 checks whether the session is present (S110) and determines that the session is present (S110: YES), the processing proceeds to S605.

At S605, the web browser 200 transmits the event notification of the MFP 6000 to the web application 209. Specifically, the web browser 200 transmits, to the web application 209, the event of transition to the energy saving mode.

Subsequently, At S610, the web application 209 transmits an event log to the web server 222, and the web server 222 stores the event log in the HDD 361.

Accordingly, the web browser 200 is able to make a request to the web server 222 for the cloud connection mode. Further, the web browser 200 is able to notify the web application 209 of the event of return from the energy saving mode.

Thus, the web server 222 is able to accept the request for the cloud connection mode. Further, the web application 209 is able to recognize the event of return from the energy saving mode.

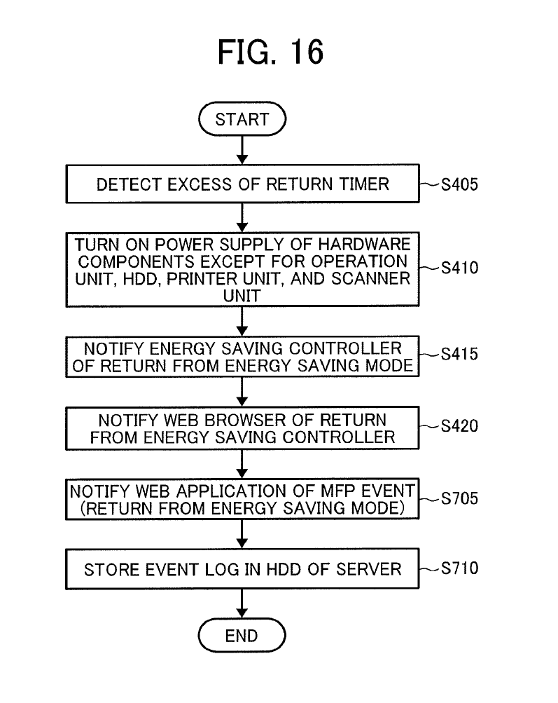

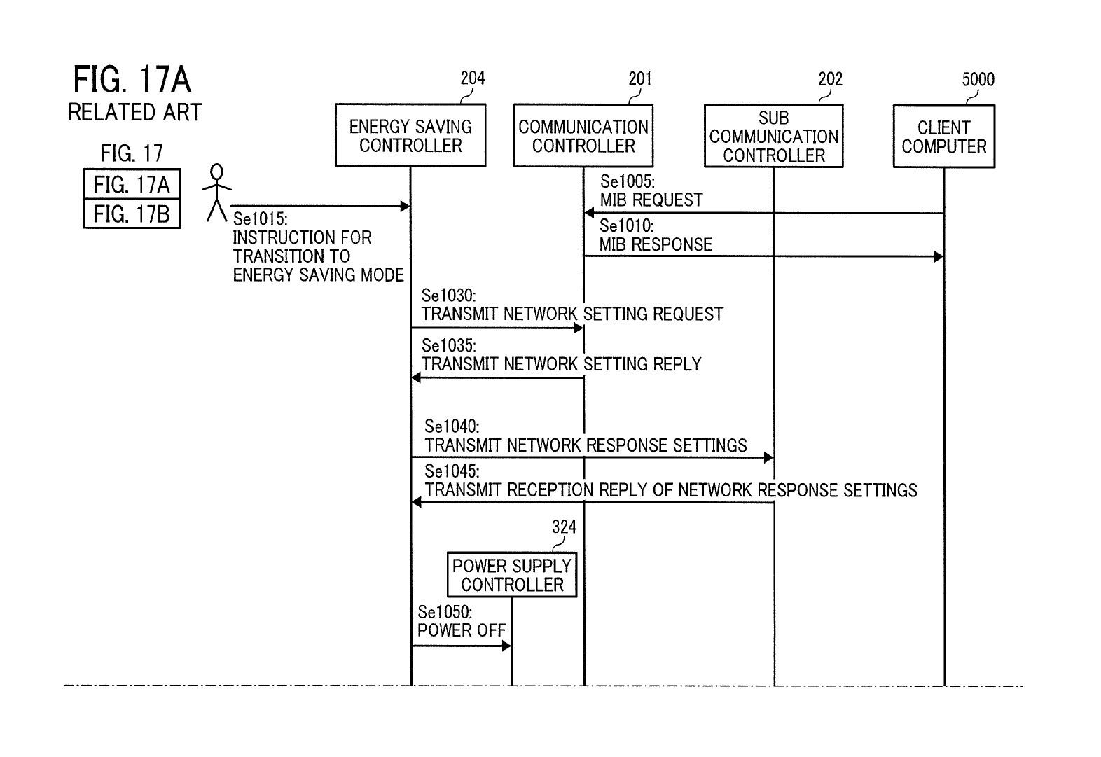

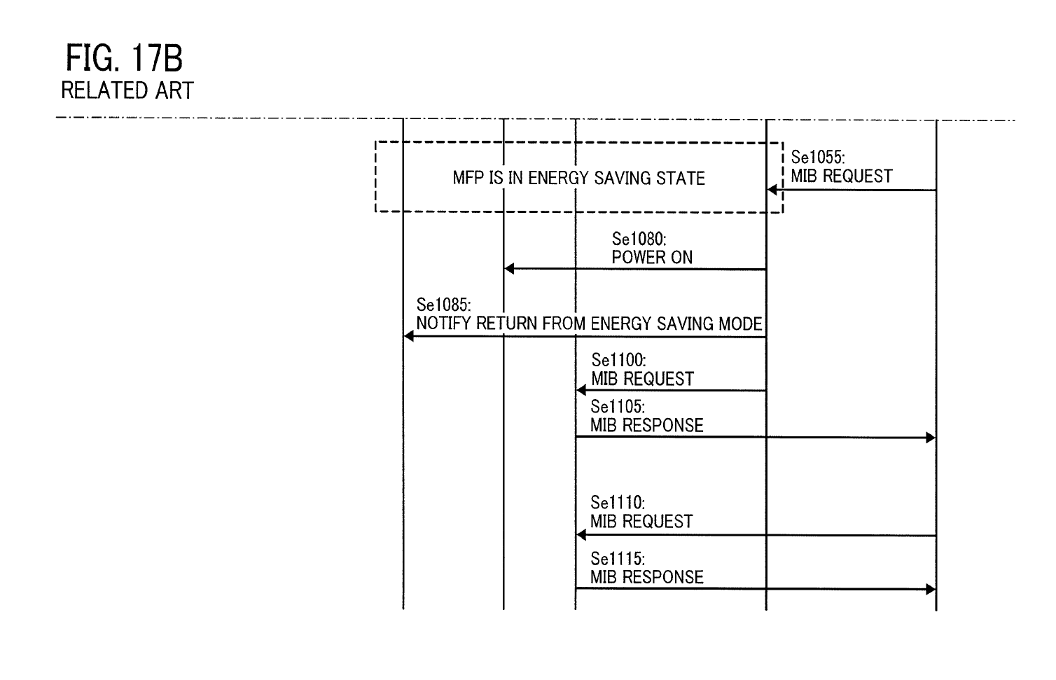

Hereinafter, a description is given of an operation performed by the MFP 6000 of returning from the energy saving mode and continuing the session according to this embodiment. FIG. 16 is a flowchart for explaining the operation performed by the MFP 6000 of returning from the energy saving and continuing the session.

In FIG. 16, the same step numbers are allocated to the same operations as those in the flowchart of FIG. 11, and redundant descriptions thereof are omitted below. Accordingly, the description is given of operations that are different from those in the flowchart of FIG. 11.

In this embodiment, after the energy saving controller 204 transmits the notification of return from the energy saving mode to the web browser 200 (S420), the processing proceeds to S705.

At S705, the web browser 200 transmits the event notification of the MFP 6000 to the web application 209. Specifically, the web browser 200 transmits, to the web application 209, the event of return from the energy saving mode.

Subsequently, at 5710, the web application 209 transmits the event log to the web server 222, and the web server 222 stores the event log in the HDD 361.

Accordingly, the energy saving controller 204 turns on power only to the hardware components necessary in the cloud connection mode and turns off power to the other hardware components. Further, the web browser 200 receives the instruction for image formation from the web server 222 and executes the received instruction. Furthermore, the web application 209 causes the web browser 200 to display a status of the event issued in the MFP 6000. Still further, the web application 209 transmits the log to the web server 222. Still further, when the MFP 6000 transitions to the energy saving mode, the web browser 200 calculates the timeout period during which the cloud connection mode is to be maintained, and sets the timeout period as the period of time for return from the energy saving mode. Still further, the web browser 200 transmits, to the web server 222, the event of transition to the energy saving state indicating that the MFP 6000 transitions to the energy saving state.

Accordingly, the web server 222 is able to recognize the period of time for return from the energy saving mode and the event of transition to the energy saving mode.

Hereinafter, a description is given of a comparative example according to a related art, in which an MFP returns from an energy saving mode in response to receiving a MIB request and the energy saving state is interrupted with reference to FIGS. 17A and 17B.

At Se1005, a client computer sends a MIB request to a communication controller. At Se1010, the communication controller of the MFP transmits, to the client computer, a MIB response to the MIB request transmitted from the client computer.

At Se1015, an energy saving controller of the MFP receives a user instruction for transition to the energy saving mode input via an operation unit. At Se1030, the energy saving controller transmits a network setting request to the communication controller in order to execute the user instruction.

At Se1035, the communication controller transmits a network setting reply to the energy saving controller.

At Se1040, the energy saving controller transmits network response settings to the sub communication controller of the MFP.

At Se1045, the sub communication controller transmits a reception reply to the network response settings to the energy saving controller.

At Se1050, the energy saving controller transmits an instruction for turning off a power supply to the power supply controller 324.

In response to receiving the instruction for turning off the power supply from the energy saving controller, the power supply controller causes the MFP to transition to the energy saving mode.

When the client computer transmits the MIB request to the sub communication controller while the MFP 6000 is in the energy saving mode, the sub communication controller 202 accepts the MIB requests transmitted from the client computer (Se1055). Then, at Se1080, the sub communication controller transmits, to the power supply controller, an instruction for turning on the power supply.

At Se1085, the sub communication controller notifies the energy saving controller of the return from the energy saving mode.

At Se1100, the sub communication controller transmits, to the communication controller, the MIB request received from the client computer.

At Se1105, the communication controller transmits, to the client computer, a MIB response to the MIB request transmitted from the client computer via the sub communication controller.

At Se1110, the client computer sends another MIB request to the communication controller. At Se1010, the communication controller transmits, to the client computer, a MIB response to the MIB request transmitted from the client computer.

Thus, as illustrated in the sequence diagram of FIGS. 17A and 17B according to the related art, when once the MFP 6000 receives the MIB requests from the client computer at Se1055, the communication controller returns from the energy saving mode.

In other words, the larger the number of client computers that make an inquiry to the MIB of the network management protocol SNMP, the shorter the period of time during which the communication controller or the main CPU is maintained in the energy saving state.

Further, in an apparatus that performs various processing by cloud computing while connecting to the cloud, it is difficult to maintain the main CPU in the energy saving state because the main CPU responds to the MIB request.

The MFP 6000 (image forming apparatus) according to an aspect of the present invention includes the network controller 318 (network interface), the web browser 200, the MFP setting unit 203 (a mode setting unit), and the communication controller 201 (a port closing unit). The network controller 318 is configured to connect to the web server 222 (server apparatus) and the client computer 5000 (information processing apparatus). The web server 222 includes the web application 229 that controls image formation by the MFP 6000. The client computer 5000 transmits job data for image formation to the MFP 6000. The web browser 200 connects to the web application 229 included in the web server 222 via the network controller 318. The web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the printer unit 317 performs image formation based on the print job data transmitted from the client computer 5000. In the cloud connection mode, the web browser 200 connects to the web application 209 and causes the printer unit 317 to perform image formation in accordance with the instruction received from the web application 229. When the cloud connection mode is set, the communication controller 201 closes the network port that is not necessary in the cloud connection mode.

According to this aspect, the web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the MFP 6000 performs image formation based on the print job data transmitted from the client computer 5000. In the cloud connection mode, the web browser 200 connects to the web application 229, and causes the printer unit 317 to perform image formation based on an instruction received from the web application 229. When the cloud connection mode is set, the network port that is not necessary in the cloud connection mode is closed.

As described heretofore, when the cloud connection mode is set, the network port that is not necessary in the cloud connection mode is closed. Accordingly, the cloud connection state is maintained, and the energy saving state is maintained as long as possible.

The MFP 6000 (image forming apparatus) according to another aspect of the present invention includes the energy saving controller 204 (an energy saving control unit). The energy saving controller 204 turns on power only to the hardware components necessary in the cloud connection mode and turns off power to the other hardware components. When the MFP 6000 transitions to the energy saving mode, the web browser 200 calculates the timeout period during which the cloud connection mode is to be maintained, and sets the timeout period as the period of time for return from the energy saving mode.

According to this aspect, the energy saving controller 204 turns on power only to the hardware components necessary in the cloud connection mode and turns off power to the other hardware components. Further, when the MFP 6000 transitions to the energy saving mode, the web browser 200 calculates the timeout period during which the cloud connection mode is to be maintained, and sets the timeout period as a period of time for return from the energy saving mode.

Thus, electric power is supplied only to the hardware components necessary in the cloud connection mode, while electric power supply to the other hardware components is stopped. Accordingly, the MFP6000 receives the instruction for image formation from the web server 222 and executes the received instruction. Furthermore, when the MFP 6000 transitions to the energy saving mode, the MFP6000 calculates the timeout period during which the cloud connection mode is to be maintained, and sets the timeout period as the period of time for return from the energy saving mode.

Accordingly, the cloud connection state is maintained until the period of time for return from the energy saving mode has passed, and the energy saving state is maintained as long as possible.

According to still another aspect of the present invention, the web browser 200 transmits the session continuation notification to the web server 222 when the MFP 6000 returns from the energy saving mode.

According to this aspect, the web browser 200 transmits the session continuation notification to the web server 222 when the MFP 6000 returns from the energy saving mode.

Thus, when the MFP 6000 returns from the energy saving mode, the web browser 200 transmits the session continuation notification to the web server 222, and thereby the session is maintained. When it reaches the time for transition to the energy saving mode, the MFP 6000 again transitions to the energy saving mode.

Accordingly, because the session is maintained, the cloud connection state is maintained, while the energy saving state is maintained as long as possible.

The MFP 6000 (image forming apparatus) according to still another aspect of the present invention includes the energy saving controller 204 (an energy saving control unit) and the web application 209 (a management unit). The energy saving controller 204 turns on power only to the hardware components necessary in cloud connection mode and turns off power to the other hardware components. The web application 209 causes the web browser 200 to display the status of the event issued in the image forming apparatus, and transmits the log to the web server 222. When the MFP 6000 transitions to the energy saving mode, the web browser 200 calculates the timeout period during which the cloud connection mode is to be maintained, and sets the timeout period as the period of time for return from the energy saving mode. Further, the web browser 200 transmits, to the web server 222, the event of transition to the energy saving state indicating that the MFP 6000 transitions to the energy saving state.

According to this aspect, the energy saving controller 204 turns on power only to the hardware components necessary in the cloud connection mode and turns off power to the other hardware components. The web application 209 causes the web browser 200 to display the status of the event issued in the image forming apparatus, and transmits the log to the web server 222. When the MFP 6000 transitions to the energy saving mode, the web browser 200 calculates the timeout period during which the cloud connection mode is to be maintained, and sets the timeout period as a period of time for return from the energy saving mode. Further, the web browser 200 transmits, to the web server 222, the event of transition to the energy saving mode indicating that the MFP 6000 transitions to the energy saving mode.

Thus, electric power is supplied only to the hardware components necessary in the cloud connection mode, while electric power supply to the other hardware components is stopped. Further, the MFP 6000 receives the instruction for image formation from the web server 222 and executes the received instruction. Furthermore, the web application 209 causes the web browser 200 to display the status of the event issued in the MFP 6000, and transmits the log to the web server 222. Still further, when the MFP 6000 transitions to the energy saving mode, the web browser 200 calculates the timeout period during which the cloud connection mode is to be maintained, and sets the timeout period as the period of time for return from the energy saving mode. Still further, the web browser 200 transmits, to the web server 222, the event of transition to the energy saving state indicating that the MFP 6000 transitions to the energy saving state.

Accordingly, the web server 222 is able to recognize the period of time for return from the energy saving mode and the event of transition to the energy saving mode.

According to still another aspect of the present invention, when the MFP 6000 returns from the energy saving mode, the web browser 200 (a web browser unit) makes a request to the web server 222 for the cloud connection mode. Further, the web browser 200 notifies the web application 209 (a management unit) of the event of return from the energy saving mode.

According to this aspect, when the MFP 6000 returns from the energy saving mode, the web browser 200 makes the request to the web server 222 for the cloud connection mode. Further, the web browser 200 notifies the web application 209 of the event of return from the energy saving mode.

Accordingly, the web browser 200 is able to make a request to the web server 222 for the cloud connection mode. Further, the web browser 200 is able to notify the web application 209 of the event of return from the energy saving mode.

Thus, the web server 222 is able to accept the request for the cloud connection mode. Further, the web application 209 is able to recognize the event of return from the energy saving mode.

The MFP 6000 according to still another aspect of the present invention includes the network controller 318 (network interface), the web browser 200, the MFP setting unit 203 (a mode setting unit), the communication controller 201 (a port closing unit), and the energy saving controller 204 (an energy saving control unit). The network controller 318 is configured to connect to the web server 222 (server apparatus) and the client computer 5000 (information processing apparatus). The web server 222 includes the web application 229 that controls image formation by the MFP 6000. The client computer 5000 transmits job data for image formation to the MFP 6000. The web browser 200 connects to the web application 229 included in the web server 222 via the network controller 318. The web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the MFP 6000 performs image formation based on the print job data transmitted from the client computer 5000. In the cloud connection mode, the web browser 200 connects to the web application 209 and causes the printer unit 317 to perform image formation in accordance with the instruction received from the web application 229. When the cloud connection mode is set, the communication controller 201 closes the network port that is not necessary in the cloud connection mode. The energy saving controller 204 turns on power only to the hardware components that is necessary for the cloud connection mode and turns off power to the other hardware components. The web browser 200 receives the instruction for image formation from the web server 222 and executes the instruction. The web browser 200 calculates a timeout period during which the web browser 200 maintains the cloud connection mode, and sets the timeout period as a period of time for return from the energy saving mode.

According to this aspect, the web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the MFP 6000 performs image formation based on the print job data transmitted from the client computer 5000. In the cloud connection mode, the web browser 200 connects to the web application 229, and causes the printer unit 317 to perform image formation based on an instruction received from the web application 229. When the cloud connection mode is set, the network port that is not necessary in the cloud connection mode is closed. The energy saving controller 204 turns on power to the hardware components necessary in the cloud connection mode and turns off power to the other hardware components. The web browser 200 receives the instruction for image formation from the web server 222 and executes the instruction. Further, when the MFP 6000 transitions to the energy saving mode, the web browser 200 calculates the timeout period during which the cloud connection mode is to be maintained, and sets the timeout period as the period of time for return from the energy saving mode.

Thus, when the cloud connection mode is set, the network port that is not necessary in the cloud connection mode is closed. Further, when the cloud connection mode is set, power to the hardware components used in the cloud connection mode is turned on, while power to the other hardware components is turned off. The MFP 6000 receives the instruction for image formation from the web server 222 and executes the received instruction. Furthermore, when the MFP 6000 transitions to the energy saving mode, the web browser 200 calculates the timeout period during which the cloud connection mode is to be maintained, and sets the timeout period as the period of time for return from the energy saving mode.

Accordingly, the cloud connection state is maintained until the period of time for return from the energy saving mode has passed, and thereby the energy saving state is maintained as long as possible.

A method for managing an energy saving state according to an aspect of the present invention is performed by the MFP 6000 including the network controller 318 (network interface). The network controller 318 is configured to connect to the web server 222 (server apparatus) and the client computer 5000 (information processing apparatus). The web server 222 includes the web application 229 that controls image formation by the MFP 6000. The client computer 5000 transmits job data for image formation to the MFP 6000. The method includes connecting to the web application 229 included in the web server 222 via the network controller 318 to receive, from the web application 229, an instruction for controlling formation of an image and form the image in accordance with the instruction received from the web application 229. The method further includes setting either one of the network connection mode and the cloud connection mode (S10). In the network connection mode, the image formation is performed based on the print job data transmitted from the client computer 5000. In the cloud connection mode, the image formation is performed based in accordance with the instruction received from the web application 229. The method further includes closing the network port that is not necessary in the cloud connection mode (S30) when the cloud connection mode is set.

According to this aspect, the method includes receiving, from the web application 209, an instruction for controlling formation of an image and forming the image in accordance with the instruction. Further, the method includes setting either one of the network connection mode and the cloud connection mode. In the network connection mode, the MFP 6000 performs image formation based on the print job data transmitted from the client computer 5000. In the cloud connection mode, the web browser 200 connects to the web application 229, and the MFP 6000 performs image formation based on an instruction received from the web application 229. Furthermore, the method includes closing the network port that is not necessary in the cloud connection mode, when the cloud connection mode is set.

As described heretofore, when the cloud connection mode is set, the network port that is not necessary in the cloud connection mode is closed. Accordingly, the cloud connection state is maintained, and the energy saving state is maintained as long as possible.

A method for managing an energy saving state according to another aspect of the present invention is performed by the MFP 6000 including the network controller 318 (network interface). The network controller 318 is configured to connect to the web server 222 (server apparatus) and the client computer 5000 (information processing apparatus). The web server 222 includes the web application 229 that controls image formation by the MFP 6000. The client computer 5000 transmits job data for image formation to the MFP 6000. The method includes connecting to the web application 229 included in the web server 222 via the network controller 318 to receive, from the web application 229, an instruction for controlling formation of an image and form the image in accordance with the instruction received from the web application 229. The method further includes setting either one of the network connection mode and the cloud connection mode (S10). In the network connection mode, the image formation is performed based on the print job data transmitted from the client computer 5000. In the cloud connection mode, the image formation is performed based in accordance with the instruction received from the web application 229. The method further includes closing the network port that is not necessary in the cloud connection mode (S30) when the cloud connection mode is set. The method further includes turning on power to the hardware component that is necessary for the cloud connection mode and turning off power to the other hardware components (S140). When the MFP 6000 transitions to the energy saving mode, the web browser 200 calculates a timeout period during which the energy saving mode is to be maintained, and sets the timeout period as a period of time for return form the energy saving mode.

According to this aspect, the method includes receiving, from the web application 209, an instruction for controlling formation of an image and forming the image in accordance with the instruction. Further, the method includes setting either one of the network connection mode and the cloud connection mode (S10). In the network connection mode, the MFP 6000 performs image formation based on the print job data transmitted from the client computer 5000. In the cloud connection mode, the web browser 200 connects to the web application 229, and the MFP 6000 performs image formation based on an instruction received from the web application 229. Furthermore, the method includes closing the network port that is not necessary in the cloud connection mode, when the cloud connection mode is set. Still further, the method includes turning on power to the hardware components necessary in the cloud connection mode and turning off power to the other hardware components. The web browser 200 receives the instruction for image formation from the web server 222 and executes the instruction. Further, when the MFP 6000 transitions to the energy saving mode, the web browser 200 calculates the timeout period during which the cloud connection mode is to be maintained, and sets the timeout period as the period of time for return from the energy saving mode.

Thus, when the cloud connection mode is set, the network port that is not necessary in the cloud connection mode is closed. Further, when the cloud connection mode is set, power to the hardware components used in the cloud connection mode is turned on, while power to the other hardware components is turned off. The MFP 6000 receives the instruction for image formation from the web server 222 and executes the received instruction. Further, when the MFP 6000 transitions to the energy saving mode, the web browser 200 calculates the timeout period during which the cloud connection mode is to be maintained, and sets the timeout period as a period of time for return from the energy saving mode.

Accordingly, the cloud connection state is maintained until the period of time for return from the energy saving mode has passed, and thereby the energy saving state is maintained as long as possible.

A program according to an aspect of the present invention causes a processor to either one of the above methods for managing the energy saving state.

According to this aspect, the processor performs either one of the above methods for managing the energy saving state according to the program.

Thus, the operational effect similar to that of the above methods is produced.

The image forming system 1 according to an aspect of the present invention includes the web server 222 (server apparatus), the client computer 5000 (information processing apparatus), and the MFP 6000 (image forming apparatus). The web server 222 includes the web application 229 that controls image formation. The client computer 5000 transmits job data for image formation to the MFP 6000. The MFP 6000 connects to the web server 222 and the client computer 5000 via the network controller 318. The MFP 6000 includes the web browser 200, the MFP setting unit 203 (a mode setting unit), and the communication controller 201 (a port closing unit). The web browser 200 connects to the web application 229 included in the web server 222 via the network controller 318. The web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the MFP 6000 performs image formation based on the print job data transmitted from the client computer 5000. In the cloud connection mode, the web browser 200 connects to the web application 209 and causes the printer unit 317 to perform image formation in accordance with the instruction received from the web application 229. When the cloud connection mode is set, the communication controller 201 closes the network port that is not necessary in the cloud connection mode.

According to this aspect, in the MFP 6000, the web browser 200 receives, from the web application 229, an instruction for controlling formation of an image, and causes the printer unit 317 to form the image in accordance with the instruction received from the web application 229. The MFP setting unit 203 sets either one of the network connection mode and the cloud connection mode. In the network connection mode, the MFP 6000 performs image formation based on the print job data transmitted from the client computer 5000. In the cloud connection mode, the web browser 200 connects to the web application 229, and causes the printer unit 317 to perform image formation based on an instruction received from the web application 229. When the cloud connection mode is set, the network port that is not necessary in the cloud connection mode is closed.

Thus, when the cloud connection mode is set, the network port that is not necessary in the cloud connection mode is closed. Accordingly, the cloud connection state is maintained, and the energy saving state is maintained as long as possible.

The image forming system 1 according to another aspect of the present invention connects to the web server 222 (server apparatus) and the client computer 5000 (information processing apparatus) via the network controller 318 (network interface). The web server 222 includes the web application 229 that controls image formation. The client computer 5000 transmits job data for image formation to the MFP 6000. The image forming system 1 includes a computer-executable program and the MFP 6000. The program causes the computer to execute a method including: connecting to the web application 229 included in the web server 222 via the network controller 318; receiving, from the web application 229, an instruction for controlling formation of an image to cause the image forming unit 205 to form the image in accordance with the instruction received from the web application 229; setting either one of the network connection mode and the cloud connection mode (S10); and when the cloud connection mode is set, closing the network port that is not necessary in the cloud connection mode (S30). In the network connection mode, the MFP 6000 performs image formation based on the print job data transmitted from the client computer 5000. In the cloud connection mode, the web browser 200 connects to the web application 209 and causes the printer unit 317 to perform image formation in accordance with the instruction received from the web application 229. The MFP 6000 receives the instruction for controlling formation of the image from the web application 229 via the network port that is necessary in the cloud connection mode.

According to this aspect, the method includes receiving an instruction for controlling formation of an image from the web application 209 via the web browser 200, and forming the image in accordance with the instruction. Further, the method includes setting either one of the network connection mode and the cloud connection mode. In the network connection mode, the MFP 6000 performs image formation based on the print job data transmitted from the client computer 5000. In the cloud connection mode, the web browser 200 connects to the web application 229, and the MFP 6000 performs image formation based on the instruction received from the web application 229. Furthermore, the method includes closing the network port that is not necessary in the cloud connection mode, when the cloud connection mode is set. Further, the method includes receiving an instruction for controlling formation of an image from the web application 229 via network port that is necessary in the cloud connection mode.

Accordingly, when the cloud connection mode is set, the network port that is not necessary in the cloud connection mode is closed. Further, the MFP 6000 is able to receive the instruction for controlling formation of the image from the web application via the network port that is necessary in the cloud connection mode.

Thus, when the cloud connection mode is set, the network port that is not necessary in the cloud connection mode is closed. Further, the MFP 6000 is able to receive the print job data from the web server 222 via the network port used in the cloud connection mode. Accordingly, the MFP 6000 is able to receive the print job data from the web server 222 in the cloud connection state and in the energy saving state.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An image forming apparatus comprising:
a network interface to connect to a server and an information processing apparatus through a network; and
circuitry to:
set either one of a first connection mode and a second connection mode;
execute a browser in the second connection mode, to cause the browser to receive from a web application installed on the server via a network port an instruction for controlling image formation by the image forming apparatus, and to control the image forming apparatus to form the image in accordance with the instruction received from the web application via the network port;
in the second connection mode, close a network port other than the network port that is used for communication with the web application in the second connection mode; and
in the first communication mode, controlling the image forming apparatus to form the image based on a print job data transmitted from the information processing apparatus.

2. The image forming apparatus of claim 1, wherein:
the circuitry is further configured to turn on power to one or more hardware components of the image forming apparatus used in the second connection mode while turning off power to another or other hardware components, to cause the image forming apparatus to transition to an energy saving mode; and
when the image forming apparatus transitions to the energy saving mode, the circuitry causes the browser to calculate a timeout period during which the second connection mode is to be kept and set the timeout period as a period of time for return from the energy saving mode.

3. The image forming apparatus of claim 2, wherein, when the image forming apparatus has returned from the energy saving mode, the circuitry causes the browser to transmit a notification for continuing a session to the server.

4. The image forming apparatus of claim 1, wherein
the circuitry is further configured to:
turn on power to one or more hardware components of the image forming apparatus used in the second connection mode while turning off power to another or other hardware components, to cause the image forming apparatus to transition to an energy saving mode;
display using the browser a status of an event issued in the image forming apparatus; and
transmit an event log to the server, and
when the image forming apparatus transitions to the energy saving mode, the circuitry causes the browser to:
calculate a timeout period during which the second connection mode is to be kept;
set the timeout period as a period of time for return from the energy saving mode; and
transmit, to the server, the event of transition to the energy saving mode.

5. The image forming apparatus of claim 4, wherein, when the image forming apparatus returns from the energy saving mode, the circuitry causes the browser to:
transmit a request for the second connection mode to the server; and
notify the web application of the event of return from the energy saving mode.

6. A method for controlling an energy saving state performed by an image forming apparatus to connect to a server and an information processing apparatus, the method comprising:
setting either one of a first connection mode and a second connection mode;
in the second connection mode,
executing a browser to cause the browser to receive from a web application installed on the server via a network port an instruction for controlling image formation by the image forming apparatus, and to control the image forming apparatus to form the image in accordance with the instruction received from the web application via the network port;
in the second connection mode, closing a network port other than the network port that is used for communication with the first web application in the second connection mode; and
in the first communication mode, controlling the image forming apparatus to form the image based on a print job data transmitted from the information processing apparatus.

7. The method of controlling the energy saving state of claim 6, further comprising:
turning on power to one or more hardware components of the image forming apparatus used in the second connection mode while turning off power to another or other hardware components to cause the image forming apparatus to transition to an energy saving mode; and
causing the browser to:
calculate a timeout period during which the second connection mode is to be kept; and
set the timeout period as a period of time for return from the energy saving mode.

8. The method of controlling the energy saving state of claim 7, further comprising causing the browser to transmit a notification for continuing a session to the server, when the image forming apparatus has returned from the energy saving mode.

9. The method of controlling the energy saving state of claim 6, further comprising:
turning on power to one or more hardware components of the image forming apparatus used in the second connection mode while turning off power to another or other hardware components to cause the image forming apparatus to transition to an energy saving mode;
displaying using the browser a status of an event issued in the image forming apparatus;
transmitting an event log to the server; and
when the image forming apparatus transitions to the energy saving mode,
causing the browser to:
calculate a timeout period during which the second connection mode is to be kept;
set the timeout period as a period of time for return from the energy saving mode; and
transmit, to the server, the event of transition to the energy saving mode.

10. The method of controlling the energy saving state of claim 9, further comprising:
when the image forming apparatus returns from the energy saving mode,
causing the browser to:
transmit a request for the second connection mode to the server; and
notify the web application of the event of return from the energy saving mode.

11. A non-transitory computer-readable medium storing a computer-executable program that, when executed, causes an image forming apparatus to connect to a server and an information processing apparatus to perform a method of controlling an energy saving state, the method comprising:
setting either one of a first connection mode and a second connection mode;
in the second connection mode,
executing a browser to cause the browser to receive from a web application installed on the server via a network port an instruction for controlling image formation by the image forming apparatus, and to control the image forming apparatus to form the image in accordance with the instruction received from the web application via the network port;
in the second connection mode, closing a network port other than the network port that is used for communication with the web application in the second connection mode; and
in the first communication mode, controlling the image forming apparatus to form the image based on a print job data transmitted from the information processing apparatus.
